(19) United States
(12) Patent Application Publication
(10) Pub. No.: US 2009/0265745 A1
(43) Pub. Date: Oct. 22, 2009

(54) Reversible Faceplate Terminal Adapter Which Changes Signal Flow Direction

(76) Inventors: John M. Egan, JR., Franktown, CO (US); Chad T. Wells, Highlands Ranch, CO (US)

Correspondence Address: JOHN R LEY, LLC, 5299 DTC BLVD, SUITE 340, GREENWOOD VILLAGE, CO, 80111, US

(21) Appl. No.: 12/104,978

(22) Filed: Apr. 17, 2008

(51) Int. Cl. H04N 7/173

(52) U.S. Cl. 725/106

(57) ABSTRACT

A directional terminal adapter has a housing and a reversible faceplate. Distribution cables of a cable network are connected to the housing and conduct downstream and upstream signals through the housing. Signals flow through the faceplate in a predetermined direction. Reversing the orientation of the faceplate with respect to the housing reverses the direction of flow of the upstream and downstream signals through the directional terminal adapter.

This invention relates to cable networks, such as cable television (CATV) networks, which conduct high-frequency signals over cables, such as coaxial cables. More particularly, the present invention relates to a new and improved directional terminal adapter which has the capability, through the orientation of a reversible faceplate, to change the direction which the high-frequency signals flow through the terminal adapter. Conveniently reversing the signal flow direction through the terminal adapter facilitates changing the configuration or cable plant of the network.

### BACKGROUND OF THE INVENTION

Cable television (CATV) companies offer television, Internet access, phone, entertainment and other useful services to subscribers. The typical medium for distributing these services is a cable network which is formed by a relatively large number of high-frequency signal-conducting conductors, such as coaxial cables, all of which are connected together to distribute the high-frequency signals to subscribers.

The high-frequency signals which deliver these services flow downstream from a central office or headend to subscribers and upstream from the subscribers back to the central office or headend, through this network of cables. Those signals which flow from the central office or headend to the subscribers are downstream signals, and the signals which flow from the subscribers to the central office or headend are upstream signals.

Because of the vast size of the cable network, and the necessity to deliver the downstream signals to the subscribers and the upstream signals to the central office, it is necessary to connect many individual segments of cables together. Such connections are made at terminal adapters. Terminal adapters constitute junctions of the cables to allow the cables to branch into the cable network. In addition to joining separate cables, terminal adapters also typically include functional components which amplify or condition the signals. The functional components may be active and draw power from connected cables to perform their functions or they may be passive and not require additional power to act on the signals carried by the cables.

Terminal adapters may also limit the direction of signal flow consistent with the layout of the cable plant. Such terminal adapters, known as directional terminal adapters, assure that the downstream signals from the central office or headend reach the subscribers and that the upstream signals from subscribers to the central office or headend are blocked from flowing through branches of the cable network that are not in a path from the subscriber to the central office or headend. Directional terminal adapters therefore both create the cable junction points throughout the cable plant while also defining the signal flow direction of the cable plant.

As the size of the cable network grows or shrinks to accommodate a changing base and geographical distribution of subscribers, it is sometimes necessary to adjust the configuration of the cable plant. For example, changing the cable plant configuration may require some branches to conduct signals in a direction opposite of the original direction, due to the changes in configuration at other points in the cable plant. Changing the direction of signal flow through a directional terminal adapter requires removing and exchanging the positions of at least two coaxial cables that are connected to the terminal adapter, thereby reversing the direction of signal flow.

Exchanging the positions of the coaxial cables connected to the terminal adapter is not a trivial undertaking.

Typically, the coaxial cable connections to the terminal adapter are waterproofed to prevent moisture from entering the terminal adapter and interfering with the functionality of its internal components. Waterproofing is achieved by placing shrinkwrap over the tightened coaxial connections between the terminal adapter and the coaxial cables and then heating the shrinkwrap so that it constricts and forms a waterproof seal. To disconnect the coaxial cables from the terminal adapter, the constricted shrinkwrap must be carefully cut away from the cable and the connectors without damaging either. The coaxial connectors are loosened and separated, and if there is sufficient length or slack in the coaxial cables, the positions of those coaxial cables is changed by connection to the opposite ports of the directional terminal adapter. New shrinkwrap must then be applied.

The process of exchanging the positions of the cables connected to a terminal adapter is time-consuming and error-prone. Cutting the shrinkwrap involves a risk that the cables will be accidently cut and damaged. Since directional terminal adapters are usually mounted in fixed positions, the cables must have enough length to reach the opposite ports of the terminal adapter; otherwise the cables must be spliced to obtain the additional length to reconnect the cables in the reversed positions. Of course, splicing the cables may require the use of another terminal adapter. Alternatively, the orientation of the terminal adapter itself must be changed in order to secure extra length to reconnect the cables in the reversed positions. It is not unusual that the entire activity of disconnecting the cables and reconnecting them in the reversed position may consume as much as an hour of time. Moreover, for the amount of time when the cables are disconnected, the signal path is interrupted causing some of the subscribers to experience an interruption in service. Although an interruption in service may be only for relatively short period of time, it may still result in complaints from the subscribers.

### SUMMARY OF THE INVENTION

The present invention permits the direction of signal flow through a directional terminal adapter to be changed quickly and conveniently while preserving service, without any necessity to disconnect or change the position or waterproofed condition of the cables connected to the directional terminal adapter.

One aspect of the invention involves a directional terminal adapter having a housing and first and second receiver ports. A detachable faceplate attaches to the housing in one of two orientations. An upstream contact point on an interior side of the faceplate connects to a different receiver port in the different orientations, thereby changing the direction of signal flow through the terminal adapter when the faceplate orientation is changed.

Another aspect of the invention involves a method of reversing flow directions of both upstream and downstream signals conducted by cables through a directional terminal adapter in a cable network. The terminal adapter has a faceplate and directional circuitry which permits the upstream and downstream signals to flow in one respectively opposite relationship. The method involves moving or rotating the faceplate from one orientation to another orientation to reverse the flow directions of both the upstream and downstream signals, and then conducting the upstream and downstream signals from the cables through the directional circuitry in the one permitted flow relationship in either orientation of the faceplate.

A more complete appreciation of the present invention and its scope may be obtained from the accompanying drawings, which are briefly summarized below, from the detailed description of a presently preferred embodiment of the invention, and from the appended claims.

### BRIEF DESCRIPTION OF THE DRAWINGS

FIG. 1 is a perspective view of a terminal adapter which incorporates the present invention, shown generally connected as part of a cable network which is represented in block diagrammatic form.

FIG. 2 is perspective view of the terminal adapter shown in FIG. 1 with a faceplate in a second orientation with respect to a housing to achieve a change in direction of signal flow through the terminal adapter compared to the direction of signal flow shown in FIG. 1.

FIG. 3 is an exploded perspective view of the terminal adapter shown in FIGS. 1 and 2, illustrating a faceplate separated from and rotated into a different perspective from a housing to illustrate certain internal components of the terminal adapter.

FIG. 4 is a cross sectional view of a housing of the terminal adapter shown in FIG. 3, taken substantially in the plane of line 4-4.

FIG. 5 is a cross-sectional view similar to FIG. 4 illustrating a different position of certain components.

### DETAILED DESCRIPTION

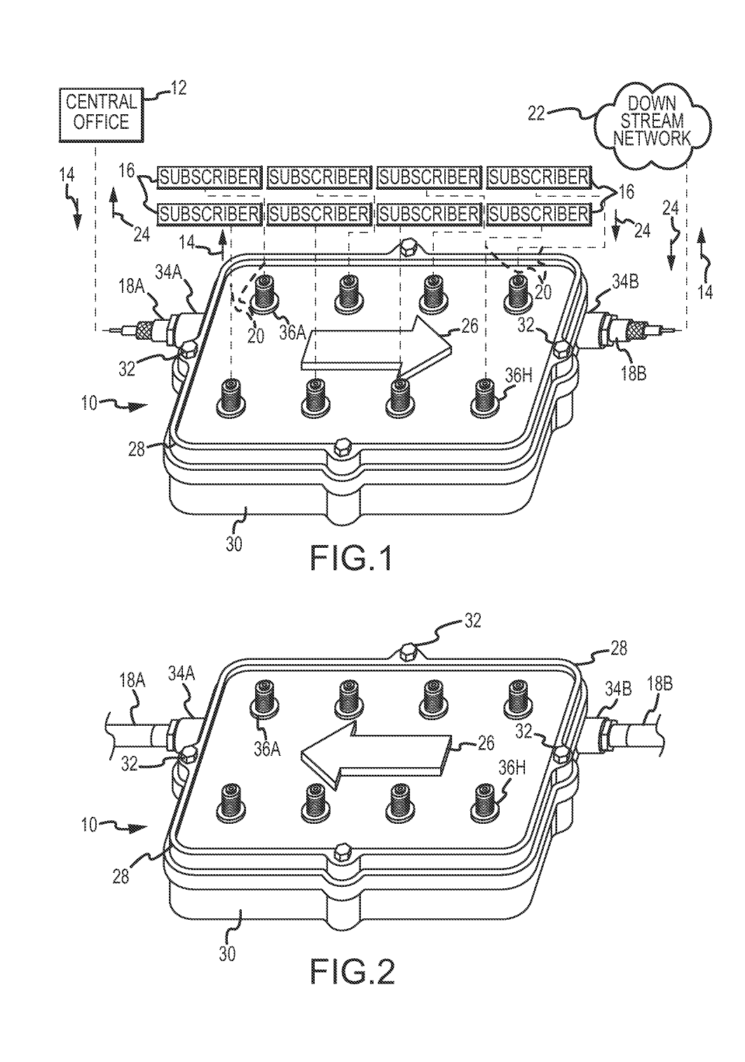

The present invention is embodied in a reversible faceplate directional terminal adapter 10, shown in FIG. 1. A headend or central office 12 sends downstream signals (shown by arrows 14) to the terminal adapter 10, and the downstream signals 14 are distributed to subscribers 16 from the terminal adapter 10. The downstream signals 14 flow from the central office 12 to the terminal adapter 10 in a distribution cable segment 18A, and from the terminal adapter 10 and through drop lines 20 to the subscribers 16. Downstream signals 14 also flow from the terminal adapter 10 through a distribution cable 18B segment to the remaining portion of a cable network 22 to which other terminal adapters 10 and other subscribers 16 are connected in a similar manner.

Upstream signals (shown by arrows 24) flow from the subscribers 16 through the drop lines 20 to the terminal adapter 10. The terminal adapter 10 directs the upstream signals 24 through the distribution cable 18A to the central office 12. The internal functional components of the terminal adapter 10 block the upstream signals 24 from the subscribers 16 from flowing in the downstream direction through the distribution cable 18B toward the remaining portion of the cable network 22. Although not shown in FIG. 1, other upstream signals from other subscribers within the cable network 22 are directed through the distribution cable 18B and blocked by other terminal adapters within the cable network 22 in essentially the same manner as is described in conjunction with the components shown in FIG. 1.

The direction of downstream signal flow through each directional terminal adapter 10 is indicated by a downstream signal flow direction indicator 26 which is embossed on, or otherwise attached to, an exterior surface of a faceplate 28 of the terminal adapter 10. The terminal adapter 10 also includes a housing 30 to which the faceplate 28 is attached with bolts 32 spaced at a midpoint along each of four sides of the terminal adapter 10. The housing 30 and the faceplate 28 are preferably constructed of metal which acts as an electrical ground reference with respect to the signals flowing through the terminal adapter 10 and the distribution cables 18A and 18B. Two receiver ports 34A and 34B are formed in the housing 30 at opposite sides of the housing 30 to receive the distribution cables 18A and 18B, respectively.

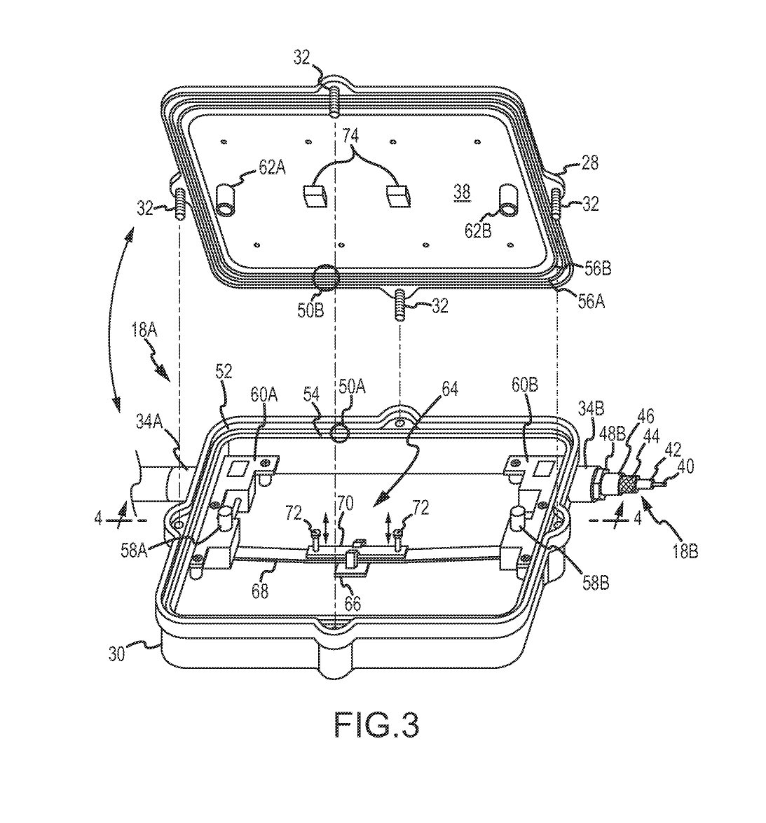

A plurality of female coaxial connectors 36A-36H are connected to the faceplate 28. The drop lines 20 are each connected to the terminal adapter 10 at one of the coaxial connectors 36A-36H, to thereby connect the subscribers 16 in the cable network to the central office 12. The downstream signals 14 and the upstream signals 24 are conducted to and from the subscribers 16 through the drop lines 20 and the internal components of the terminal adapter 10. The functional electronic components within the interior of the terminal adapter 10 are connected on an inside surface of a circuit board 38 (FIG. 3) which is attached to an inside surface of the faceplate 28. The electronic components of the circuit board 38 perform signal conditioning functions within the terminal adapter 10, such as signal amplification and signal direction blocking. The electronic components attached to the circuit board 38 control the direction of downstream signal flow from the receiver port 34A to the receiver port 34B, and control the direction of upstream signal flow from the receiver port 34B to the receiver port 34A. The electronic components also assure that the downstream signal flow 14 from the distribution cable 18A is delivered to the subscribers 16 through the coaxial connectors 36A-36H, and that the upstream signal flow 24 from the subscribers 16 received at the coaxial connectors 36A-36H is delivered to the distribution cable 18A.

The faceplate 28 is preferably symmetrical along a mid-line dividing the faceplate in the horizontal direction in one case and in a vertical direction in the other case. The symmetry of the faceplate 28 allows it to be attached to the housing 30 in a first orientation, shown in FIG. 1, where the downstream signals 14 from the central office 12 enter at receiver port 34A and exit from both receiver port 34B and the coaxial connectors 36A-36H. The symmetry of the faceplate 28 also allows it to be attached to the housing 30 in a second orientation, shown in FIG. 2, where the downstream signals 14 enter at receiver port 34B and exit at both receiver port 34A and coaxial connectors 36A-36H. The first orientation of the faceplate 28 with respect to the housing 30 results in a downstream signal flow through the directional terminal adapter 10 in a first direction, which is to the right as shown in FIG. 1, and the second orientation of the faceplate 28 with respect to the housing 30 results in a downstream signal flow through the directional terminal adapter 10 in a second direction, opposite to the first direction, which is to the left as shown in FIG. 2.

The signal flow through the directional terminal adapter 10 is changed by reversing the orientation of the faceplate 28 with respect to the housing 30. A change in the direction of a signal flow through distribution cables 18A and 18B is accommodated by reversing the faceplate 28 on the housing 30 rather than exchanging the connection of the distribution cables 18A and 18B. All of the difficulties and other time consumptive activities associated with attempting to reverse the connection position of the cables 18A and 18B is avoided entirely by changing the position of the faceplate 28. Changing the position of the faceplate 28 does nothing to modify or influence the direction of signal flow to and from the subscribers 16 through the coaxial connectors 36A-36H, because the electronic components on the circuit board 38 (FIG. 3) operate the same regardless of the position of the faceplate 28. In virtually every circumstance, there is enough length or slack in the drop lines 20 to permit the faceplate 28 to be rotated from the position shown in FIG. 1 to the position shown in FIG. 2 because there is no significant change in location of the drop lines 20 or the coaxial connectors 36A-36H when the position of the faceplate 28 is rotated.

More details concerning the directional terminal adapter 10 and the distribution cables 18A and 18B are shown in FIG. 3. Each distribution cable 18A and 18B has a central conductor 40, an internal insulator 42, a ground shield 44, and an external coating 46. The central conductor 40 conducts the upstream and downstream signals 24 and 14 (FIG. 1). The internal insulator 42 separates and insulates the central conductor 40 from the ground shield 44, and the external coating 46 waterproofs and insulates the ground shield 44. Coaxial connectors 48A and 48B at the ends of the distribution cables 18A and 18B connect to one of the receiver ports 34A and 34B of the housing 30. The coaxial connectors 48A and 48B connect the ground shield 44 to the housing 30, thereby continuing the ground reference shield along the length of each of the distribution cables 18A and 18B.

A mating surface 50A of the housing 30 contacts a mating surface 50B on the bottom of the faceplate 28. The mating surface 50A includes a rubber outer ring 52 which forms a seal for keeping moisture from entering the housing 30 when the faceplate 28 is securely connected to the housing 30 by the bolts 32. A wire mesh ring 54 is located slightly internally within the housing 30 relative to the rubber outer ring 52. The wire mesh ring 54 ensures conductivity between the housing 30 and the faceplate 28 in order to establish a ground plane reference throughout the entire outer structure of the terminal adapter 10. The mating surface 50B of the faceplate 28 has raised ridges 56A and 56B which make contact with and compress against the outer rubber ring 52 and the inner wire mesh ring 54 to create a waterproof seal and to ensure the electrical continuity between the housing 30 and the faceplate 28, respectively.

The circuit board 38 contains the electronic components which perform the signal conditioning functions described herein, including control over the upstream and downstream signal flow direction on the distribution cables 18A and 18B and on the drop lines 20 and from the subscribers 16.

Signal posts 58A and 58B are located along a longitudinal midline of the housing 30 and are spaced equidistant from the center of the housing 30. The signal posts 58A and 58B electrically connect with the center conductors 40 of the distribution cables 18A and 18B when the distribution cables 18A and 18B are connected to the receiving ports 34A and 34B by the coaxial connectors 48A and 48B. The signal posts 58A and 58B extend from insulator blocks 60A and 60B, respectively. The insulator blocks 60A and 60B are connected to the housing 30, and insulate the signal posts 58A and 58B from the housing 30. The ground shields 44 of the distribution cables 18A and 18B are electrically connected to the housing 30 through the coaxial connectors 48A and 48B.

The circuit board 38 is attached to the inside surface of the faceplate 28. In addition to supporting the circuit components which perform the signal conditioning, blocking and directional functions, the circuit board 38 also supports an upstream receptacle 62A and a downstream receptacle 62B. The receptacles 62A and 62B are positioned along a longitudinal midline of the faceplate 28 and are also positioned the same distance from the center of the faceplate as the signal posts 58A and 58B are positioned from the center of the housing 30. The receptacles 62A and 62B receive and connect with the signal posts 58A or 58B of the housing 30 when the faceplate 28 is attached to the housing 30 in each of the two reversed orientations of the faceplate 28 with respect to the housing 30.

The upstream signals from subscribers 16 entering the circuit board 38 from the coaxial connectors 36A-36H on the exterior side of the faceplate 28 are routed through the circuit board 38 to the upstream receptacle 62A and are not conducted to the downstream receptacle 62B. Upstream signals from other subscribers in the cable network 22 entering the circuit board 38 from the downstream receptacle 62B are routed through the circuit board to the upstream receptacle 62A without being conducted to the coaxial connectors 36A-36H which lead to the subscribers 16. Thus, the circuit board 38 ensures that upstream signals originating from both the subscribers 16 and the cable network 22 only flow out of the faceplate 28 through the upstream receptacle 62A.

Downstream signals from the central office 12 enter the upstream receptacle 62A and are routed through the circuit board 38 to the coaxial connectors 36A-36H leading to the subscribers 16 and to the downstream receptacle 62B leading to the cable network 22 downstream of the terminal adapter 10. The signal post 58A or 58B that is plugged into the upstream receptacle 62A conducts the upstream and downstream signals to and from the center conductors 40 of the distribution cable 18A or 18B, respectively. Likewise, the signal post 58A or 58B that is plugged into the downstream receptacle 62B conducts the downstream and upstream signals to and from the center conductors 40 of the distribution cable 18A or 18B, respectively.

Inverting the faceplate 28 in relation to the housing 30 interchanges the signal post 58A or 58B which is plugged into the upstream and downstream receptacles 62A and 62B. When the faceplate 28 is attached to the housing 30 in the first orientation as shown in FIG. 1, the upstream receptacle 62A is plugged into the signal post 58A and the downstream receptacle 62B is plugged into the signal post 58B. In this orientation, the downstream signals enter and the upstream signals exit the faceplate 28 from the signal post 58A. When the faceplate 28 is inverted into the second orientation from the position shown in FIG. 1 to the position shown in FIG. 2, the upstream receptacle 62A is plugged into the signal post 58B and the downstream receptacle 62B is plugged into the signal post 58A. The orientation of the faceplate 28 with respect to the housing 30 thus determines ports 34A and 34B.

Downstream signals entering signal post 58A and upstream signals entering signal post 58B are conducted to the other signal post 58A or 58B through the receptacles 62A and 62B and the circuit board 38 when the faceplate 28 is attached to the housing 30. A bypass bar assembly 64 conducts these signals to the other signal post 58A or 58B when the faceplate 28 is not attached to the housing 30. Without the bypass bar assembly 64, or a similar device, the signals conducted to either signal post 58A or 58B would not be conducted to the other signal post 58A or 58B when the faceplate 28 is not attached to the housing 30. Consequently, without the bypass bar assembly, the services to and from the subscribers in the cable network 22 (FIG. 1) downstream of the terminal adapter 10 would be interrupted. The bypass bar assembly 64 ensures that signal flow through the housing 30 to and from distribution cables 18A and 18B is not interrupted when the faceplate 28 is removed from the housing 30. The bypass bar assembly 64 disengages the electrical connection between the signal posts 58A and 58B when the faceplate 28 is attached to the housing 30, to assure that the circuit components on the circuit board 38 perform the signal conditioning and directional functionality when the faceplate 28 is attached.

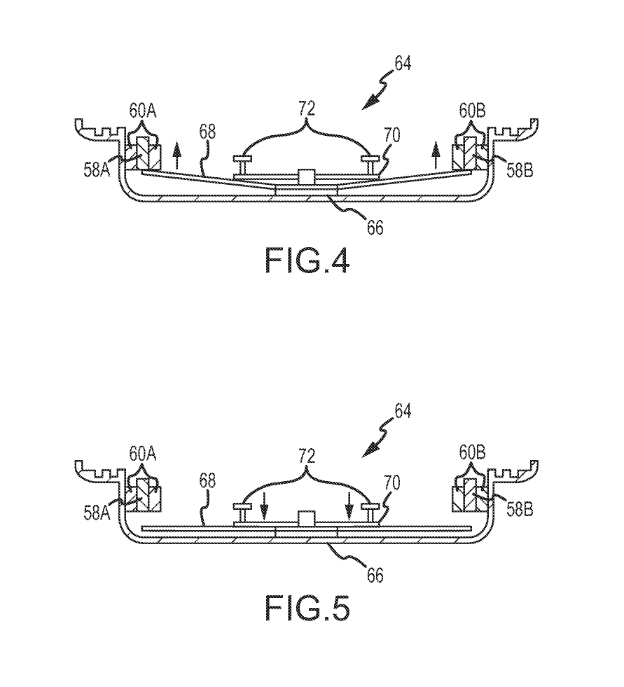

More details concerning the bypass bar assembly 64 are shown in FIGS. 4 and 5 in addition to those details shown in FIG. 3. The bypass bar assembly 64 includes an insulating base mount 66 which is attached to the housing 30. A metal strip bypass bar 68 is attached to the base mount 66. The bypass bar 68 is insulated from the housing 30 by the base mount 66. Ends of the bypass bar 68 are biased away from the housing 30 compared to its center. A disengage bar 70 sits atop the bypass bar 68 and is also attached to the base mount 66. Opposite ends of the disengage bar 70 contact the bypass bar 68 between its midpoint and its opposite ends. The vertical position of the disengage bar 70 relative to the base mount 66 determines whether or not the ends of the bypass bar 68 contact the signal posts 58A and 58B to conduct signals between the signal posts 58A and 58B.

The upward biased ends of the bypass bar 68 make contact with the bottom portions of the signal posts 58A and 58B which are exposed through the insulator blocks 60A and 60B when the disengage bar 70 is in a first position more vertically separated from the base mount 66, as shown in FIG. 4. When the disengage bar 70 is depressed downward into a second position which is less vertically separated from the base mount 66, as shown in FIG. 5, the disengage bar 70 presses down on the bypass bar 68 enough to cause the ends of the bypass bar 68 to disengage from contact with the signal posts 58A and 58B. However, in the second vertically depressed position, the disengage bar 70 does not cause the ends of the bypass bar 68 to make contact with the housing 30.

Posts 72 are attached to the disengage bar 70 and face upward within the interior of the housing 30. Contact blocks 74 are attached to the circuit board 38 to contact the posts 72 and cause the disengage bar 70 to move from the first position shown in FIG. 4 to the second position shown in FIG. 5 when the faceplate 28 is secured to the housing 30. Both the posts 72 and the contact blocks 74 are spaced equidistant from the center of the faceplate 28 and the housing 30 so that the operation of the bypass bar assembly 64 is the same regardless of the orientation of the faceplate 28 with respect to the housing 30. Disengaging the bypass bar 68 from the signal posts 58A and 58B when the faceplate 28 is attached to the housing 30 prevents upstream signals originating from the coaxial connectors 36A-36H from entering the signal post 58B associated with the downstream distribution cable 18B.

As has been described above, the directional terminal adapter 10 allows the signal flow direction to be easily and quickly reversed through the terminal adapter, by the straightforward expedient of removing the faceplate 28, inverting or changing its orientation, and reattaching it to the housing 30. The distribution cables connected to the terminal adapter do not need to be disconnected in order to change the signal flow direction. The time and difficulty of removing the coaxial cables and exchanging their positions of connection to the terminal adapter are avoided. Changing the signal flow direction through a directional terminal adapter is quickly accomplished, with minimal or no service outage for subscribers.

A presently preferred embodiment of the present invention and many of its improvements have been described with a degree of particularity. This description is a preferred example of implementing the invention, and is not necessarily intended to limit the scope of the invention. The scope of the invention is defined by the following claims.

What is claimed:

1. A directional terminal adapter for use in a cable network, the cable network having a plurality of distribution cables which carry both upstream and downstream signals, comprising:
a housing having a first receiver port and a second receiver port, each of which connects to one distribution cable;
a detachable faceplate which attaches to the housing, the faceplate having an exterior side and an interior side;
an upstream contact point on the interior side of the faceplate, the upstream contact point communicating upstream signals to one of the receiver ports when the faceplate is attached to the housing; and
the faceplate attaching to the housing in one of two orientations, the receiver port in communication with the upstream contact point being different between the orientations.

2. A directional terminal adapter as defined in claim 1, further comprising:
a downstream contact point on the interior side of the faceplate, the downstream contact point communicating downstream signals to a different receiver port than the receiver port receiving upstream signals from the upstream contact point when the faceplate is attached to the housing;
circuitry for processing signals attached to the interior side of the faceplate, the circuitry in communication with both the upstream contact point and the downstream contact point; and wherein:
downstream signals from the receiver port in communication with the upstream contact point are routed through the circuitry to the downstream contact point and associated receiver port, and upstream signals from the receiver port in communication with the downstream contact point are routed through the circuitry to the upstream contact point and associated receiver port.

3. A directional terminal adapter as defined in claim 2, further comprising:
at least one coaxial connector attached to the exterior of the faceplate and in communication with the circuitry of the faceplate, and wherein:
upstream signals entering the circuitry from the at least one coaxial connector pass through the upstream contact point to the one of the receiver ports in communication with the upstream contact point and do not pass through the downstream contact point.

4. A directional terminal adapter as defined in claim 3, wherein the upstream and downstream contact points are spaced equidistant from the center of the faceplate, the adapter further comprising:
two conducting points attached inside the housing, each conducting point in communication with one of the receiver ports of the housing, the two conducting points spaced equidistant from the center of the housing, each of the two conducting points in conductivity with one of the contact points when the faceplate is attached to the housing, and wherein:
the one of the two contact points with which each of the conducting points is in conductivity is different between the first orientation and the second orientation of the faceplate with respect to the housing.

5. A directional terminal adapter as defined in claim 4, further comprising:
at least one insulating device which is attached to the housing and which electrically insulates at least one conducting point from the housing.

6. A directional terminal adapter as defined in claim 4, further comprising:
a bypass bar assembly within the housing which creates an electrical connection between the two conducting points when the faceplate is detached from the housing, the bypass bar assembly breaking the electrical connection it previously created when the faceplate is attached to the housing, and wherein:
signals traverse the bypass bar assembly between the two receiver ports to allow communications between the two receiver ports when the faceplate is detached from the housing.

7. A directional terminal adapter as defined in claim 2, further comprising:
a signal direction indication on the faceplate which indicates the direction of one of the downstream or upstream signal flow through the directional terminal adapter.

8. A method of reversing flow directions of both upstream and downstream signals conducted by cables through a directional terminal adapter in a cable network, the terminal adapter having a faceplate and directional circuitry which permits the upstream and downstream signals to flow in one respectively opposite relationship, the method comprising:
moving the faceplate from one orientation of attachment to the housing to another different orientation of attachment to reverse the flow directions of both the upstream and downstream signals in the cables; and
conducting the upstream and downstream signals from the cables through the directional circuitry in the one permitted flow relationship in either orientation of attachment of the faceplate.

9. A method as defined in claim 8, further comprising:
indicating the direction of signal flow of one of the downstream signals or the upstream signals on the faceplate in either orientation of attachment of the faceplate.

10. A method as defined in claim 8, wherein the faceplate comprises coaxial connectors for connecting subscriber cables between the directional terminal adapter and subscribers, the subscribers originating upstream signals which enter through the coaxial connectors, the method further comprising:
conducting the downstream signals from the directional circuitry to the coaxial connectors; and
conducting subscriber originated upstream signals from the subscriber through the coaxial connectors and to the directional circuitry to the cables in the same direction as the upstream signals.

11. A method as defined in claim 8, wherein the housing further includes a bypass assembly for conducting upstream and downstream signals through the housing between the cables and the faceplate is detachable from the housing, the method further comprising:
detaching the faceplate from the housing while moving the faceplate from one orientation to the other orientation;
activating the bypass assembly to conduct the upstream and downstream signals through the terminal adapter between the cables when the faceplate is detached from the housing; and
deactivating the bypass assembly when the faceplate is attached to the housing.
